(19) United States
(12) Patent Application Publication
(10) Pub. No.: US 2025/0214547 A1
(43) Pub. Date: Jul. 3, 2025

(54) VEHICLE PUSH ROLLER SYSTEM

(71) Applicant: Cameron Worth, Riviera Beach, FL (US)

(72) Inventor: Cameron Worth, Riviera Beach, FL (US)

(21) Appl. No.: 19/004,315

(22) Filed: Dec. 28, 2024

Related U.S. Application Data
(60) Provisional application No. 63/616,441, filed on Dec. 29, 2023.

(51) Int. Cl. B60S 13/00

(52) U.S. Cl. CPC B60S 13/00

(57) ABSTRACT

A vehicle roller assembly addressing the need for a practical and efficient solution to move vehicles. The assembly comprises a frame with right and left side members, hosting a roller element for engaging the vehicle's tire, and a wheel assembly with lateral wheels providing stability. Centrally positioned within the frame is a hub wheel assembly, incorporating a motor within a hub to propel the assembly forward or backward. The motor is powered by a battery mounted at the rear of the frame, and directional control is facilitated by a controller linked to both the battery and the motor. A handle extending from the rear of the frame culminates into a throttle grip unit enabling users to initiate movement of the vehicle roller assembly by utilizing leverage to push down on the handle and simultaneously directing power to the motor using the throttle grip.

In accordance with 37 C.F.R. 1.76, a claim of priority is included in an Application Data Sheet filed concurrently herewith. Accordingly, the present invention claims priority to U.S. Provisional Patent Application No. 63/616,441, entitled “VEHICLE PUSH ROLLER SYSTEM”, filed Dec. 29, 2023. The contents of the above referenced application are incorporated herein by reference in its entirety.

### FIELD OF THE INVENTION

This present invention relates generally to the movement of vehicles. More specifically, the present invention relates to a push roller assembly having a front roller engaging the tire of a vehicle and a hub motor wheel operated by a hand controller to push a vehicle, which may be inoperable, to a desired location.

### BACKGROUND OF THE INVENTION

The invention addresses a common and critical issue encountered by drivers—the sudden inoperability of vehicles while on the road. Vehicles may become inoperative due to various reasons, such as mechanical failures, engine malfunctions, or flat tires. These situations pose significant safety risks to the drivers, as well as other road users. The need to promptly move an inoperative vehicle to a safe location is paramount to prevent traffic disruptions and potential accidents. The invention also addresses moving inoperable vehicles not on the road, for instance to enhance workflow in a mechanic's shop or personal garage space. The device may further be used for pushing racing cars, which are rarely operated under power of the engine except to race.

Moving vehicles which may be large and heavy, especially in emergency situations, is a challenging task. When a vehicle becomes inoperative, the traditional method involves a passenger placing the keys in the ignition (or activating the manual release for transmission interlock for keyless fob vehicles) and shifting the transmission into a neutral gear, or in the case of a manual transmission car, releasing the parking brake, and then physically pushing the vehicle (which may require more than one person). The passenger inside the vehicle may steer and activate the brakes in order to stop the car in a desired location. This process is not only physically demanding but also poses safety risks, as the driver inside may struggle without power steering, and stopping the vehicle can be challenging. The physical effort required and the potential for injury make this method less than ideal for addressing the urgent need to relocate an inoperative vehicle.

In mechanic shops the need to move inoperative vehicles efficiently is crucial for optimizing workflow. Mechanics often face the task of shifting vehicles between bays to create space for repairs or maintenance on other vehicles. In an alternative situation, movement of an inoperative vehicle is necessary when loading a car into an enclosed trailer for transport. In most cases, a driver cannot be present inside the vehicle when loading the vehicle into an enclosed trailer since there will not be enough room to properly exit the vehicle after the vehicle is moved into the trailer. The current methods of manual pushing or using additional vehicles for relocation are not only labor-intensive but also time-consuming, affecting the overall efficiency of the mechanic's operations in the shop or the amount of effort required to load a vehicle into an enclosed trailer.

While tow trucks are a common solution for moving inoperative vehicles, relying on them has drawbacks. Waiting for a tow truck on the road is inconvenient and time-consuming. In a mechanic's shop, using a tow truck for internal vehicle movement is cumbersome and may disrupt the workflow. Hence, there is a clear need for a compact and portable device that can be easily stored in a vehicle and may be used in emergency situations to provide a quick and efficient means to move an inoperative vehicle to a safe location, or conveniently stored in a mechanic's shop or personal garage. The device may operate on a rechargeable or replaceable battery, ensuring its reliability in various situations without adding complexity to the user experience. This invention addresses these challenges by introducing a push roller assembly with a front roller and hub motor wheel, controlled by a hand controller, offering a practical and convenient solution for moving inoperative vehicles in a safe and efficient manner.

### SUMMARY OF THE INVENTION

The disclosed invention addresses the critical need for a practical and efficient solution to move inoperative vehicles, offering a compact and portable vehicle roller assembly. When a vehicle becomes inoperative, traditional methods, such as manual pushing or relying on tow trucks, are not only labor-intensive but also time-consuming and expensive. The proposed assembly comprises a frame with right and left side members, hosting a roller element for engaging the vehicle's tire, and a wheel assembly with lateral wheels for stability. Centrally positioned within the frame is a hub wheel assembly, incorporating a motor within a hub to propel the assembly forward or backward. The motor is powered by a battery mounted at the rear of the frame, and directional control is facilitated by a controller linked to both the battery and the motor.

The vehicle roller assembly includes a handle extending from the rear of the frame, culminating in a throttle grip unit. This design enables users to initiate movement of the vehicle roller assembly by utilizing leverage to push down on the handle and simultaneously direct power from the battery to the motor using the throttle grip. The assembly's compact and portable nature allows it to be easily stored in a vehicle, ready for use in emergency situations, or conveniently stored in a mechanic's shop or personal garage. By providing a user-friendly and efficient means of moving inoperative vehicles, the invention mitigates the safety risks associated with manual pushing, enhances the convenience of vehicle relocation in mechanic shops, and eliminates the need to wait for tow trucks. Overall, this invention resolves the challenges associated with moving inoperative vehicles by offering a versatile, battery-powered, and user-controlled solution.

In one exemplary embodiment, the present invention provides a vehicle roller assembly for movement of a vehicle including: a frame having a right side member spaced apart from a left side member, the right side member having a front end and a rear end with an upper edge and a lower edge defining an inner side surface and an outer side surface, the left side member forming a mirror image of the right side member; a roller element rotatably positioned between the right side member and the left side member approximate the front end; a wheel assembly positioned adjacent to the roller assembly, the wheel assembly having a first lateral wheel located along the outer side surface of the right side member and a second lateral wheel located along the outer side surface of the left side member supported by a common axle therebetween; a hub wheel assembly centrally positioned between the front end and the rear end of the frame and the side members, the hub wheel assembly including a motor positioned within a hub, the motor constructed and arranged to provide rotation of a wheel mounted to the hub in a forward or reward direction for propelling the frame; a battery mounted along the rear end of the frame and electrically coupled to the motor; a controller coupled to the battery and the motor providing directional control of the hub assembly; a handle having a proximal end secured to the rear end of the frame and extending outwardly therefrom to a distal end; and a throttle grip unit fastened to the distal end of the handle, wherein the throttle grip (rheostat or digital control) is used to direct power from the battery to the motor to initiate movement of the vehicle roller assembly.

It will also be appreciated that various combinations of the features disclosed hereafter for a vehicle roller assembly are also possible as desired.

### BRIEF DESCRIPTION OF THE FIGURES

The present invention is illustrated and described herein with reference to the various drawings, in which like reference numbers are used to denote like system components/method steps, as appropriate, and in which:

FIG. 1 is a perspective side environmental view of a vehicle roller assembly engaged with the wheel of a vehicle;

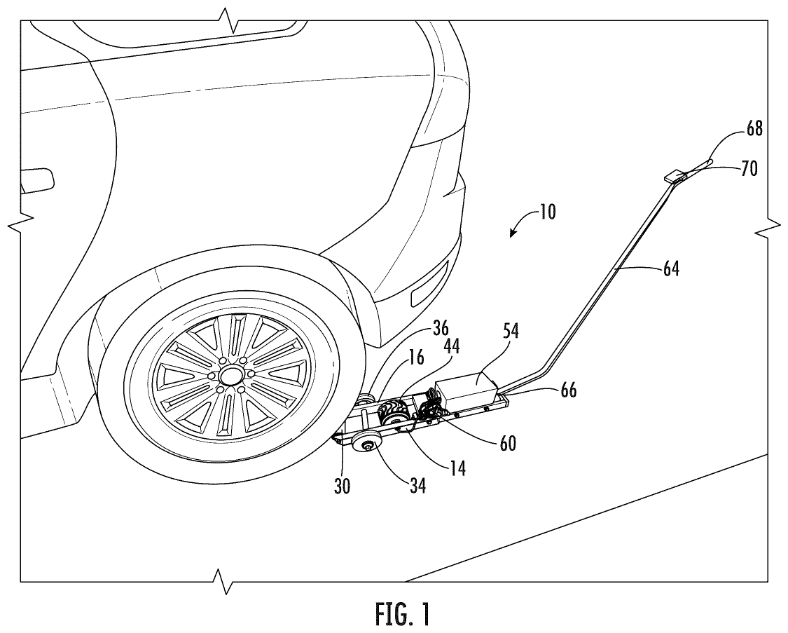

FIG. 2 is a perspective side view of the vehicle roller assembly engaged with the wheel of a vehicle;

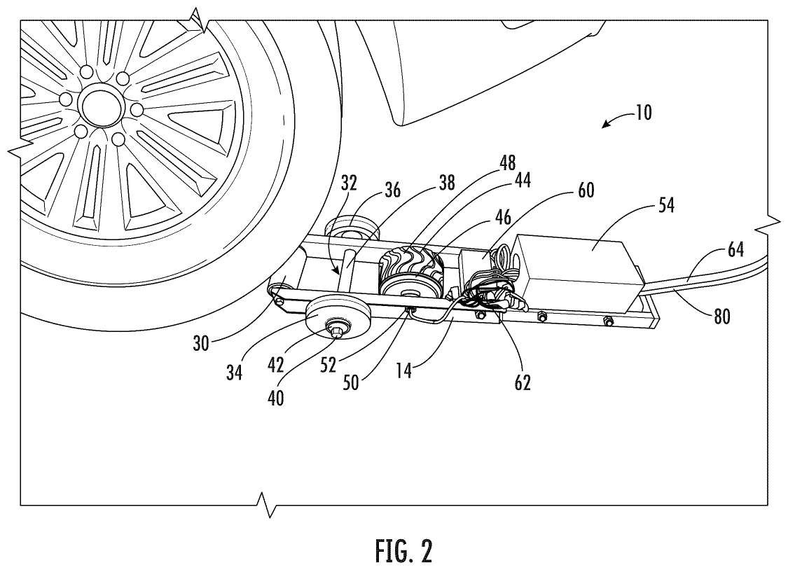

FIG. 3 is a perspective side view of the vehicle roller assembly;

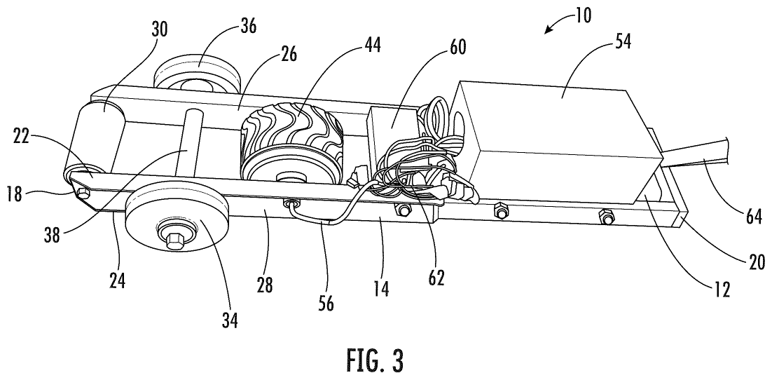

FIG. 4 is a top view of the vehicle roller assembly;

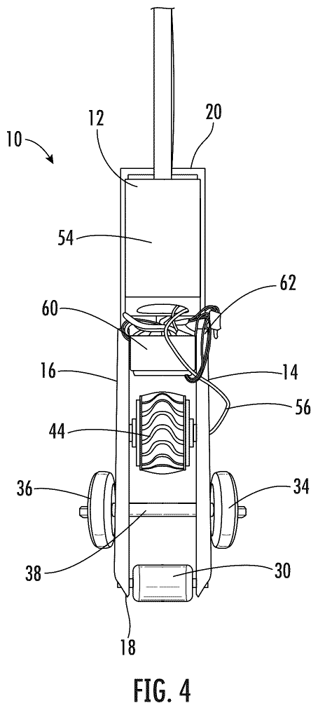

FIG. 5 is a perspective front view of the vehicle roller assembly;

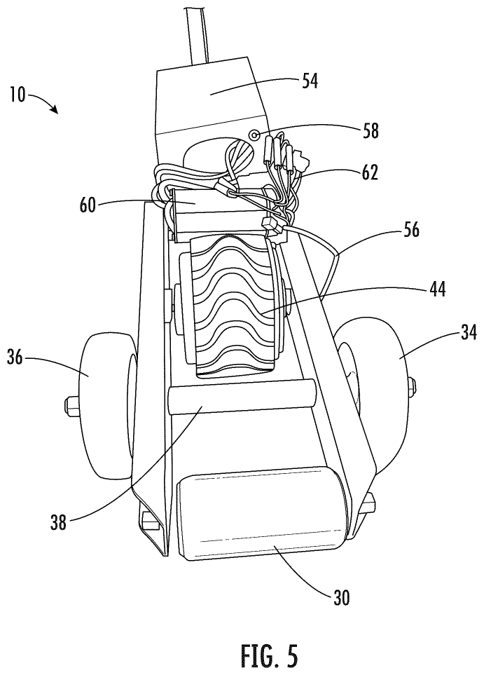

FIG. 6 is a top view of a throttle grip unit; and

FIG. 7 is a perspective top view of the vehicle roller assembly.

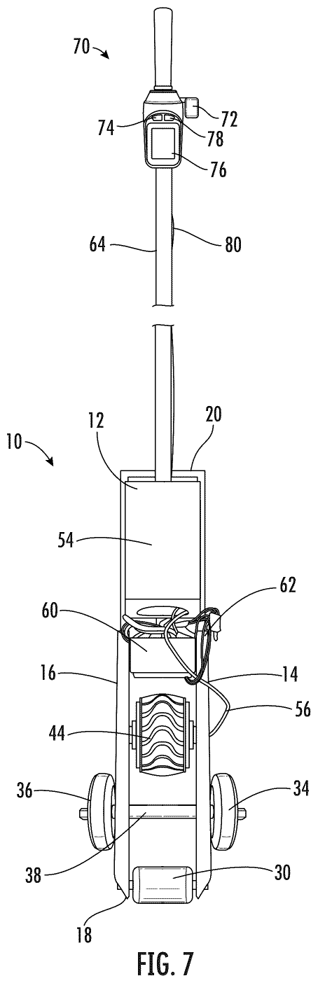

### DETAILED DESCRIPTION OF THE INVENTION

While the present invention is susceptible of embodiment in various forms, there is shown in the drawings and will hereafter be described a presently preferred, albeit not limiting, embodiment with the understanding that the present disclosure is to be considered an exemplification of the present invention and is not intended to limit the invention to the specific embodiments illustrated.

Referring now to the figures, in one exemplary embodiment, a vehicle roller assembly 10 includes a frame 12 having a right side member 14 and a left side member 16 spaced a distance away from each other. The right side member 14 is defined by a front end 18 and a rear end 20 with an upper edge 22 and a lower edge 24 defining an inner side surface 26 and an outer side surface 28. In a preferred embodiment, the right side member 14 and the left side member 16 are equivalent in shape and size, or a mirror image of each other. The frame 12, including the right side member 14 and the left side member 16, are not limited in shape, size, or material. Material may be sheet metal, stainless steel, aluminum, carbon fiber, polymer-based material, or any similar material suitable to withstand the loads being applied from interaction with the vehicle.

A roller element 30 rotatably positioned between the right side member 14 and the left side member 16 is present and located approximate to the front end 18. The roller element 30 is intended to engage with the wheel or tire of a vehicle to provide a rotatable means of contact between the road surface and the wheel, greatly enhancing the ability to move the vehicle. The roller element 30 is preferably a low-friction roller which greatly reduces the resistance between the roller element 30 and the wheel, allowing for more efficient movement. Additionally, a low-friction roller provides a smooth finish which helps minimize wear and tear on both the roller element 30 and the wheel of the vehicle. Reduced friction decreases the likelihood of abrasion and damage to the surfaces in contact, prolonging the lifespan of the roller element 30 and the tires of the vehicles being moved.

The overall functionality of the vehicle roller assembly 10 is supported by a wheel assembly 32 positioned adjacent to the roller assembly 30. The wheel assembly 32 includes a first lateral wheel 34 located along the outer side surface 28 of the right side member 14 and a second lateral wheel 36 located along the outer side surface 28 of the left side member 16 supported by a common axle 38 therebetween. The lateral wheels 34, 36 are secured to the frame 12 by screws 40 and washers 42. This configuration helps maintain stability during vehicle movement.

By supporting the frame 12 on both sides, the lateral wheels 34, 36 prevent unnecessary tilting or wobbling, ensuring that the vehicle roller assembly 10 moves smoothly and in a controlled manner. The lateral wheels 34, 36, along with the roller element 30, contribute to an even distribution of the vehicle's weight. This balanced distribution is essential for preventing uneven pressure on the roller element 30 and the tire of the inoperative vehicle. It helps avoid excessive wear on specific components and ensures that the assembly can effectively handle various vehicle weights without compromising its integrity.

While the vehicle roller assembly 10 engages with the vehicle's tire for forward or backward movement, the lateral wheels 34, 36 assist in maintaining the intended direction. They help guide the vehicle roller assembly 10 along a straight path, preventing unintentional veering or drifting during operation. This is particularly important for precise maneuvering, especially in confined spaces, such as a mechanic's shop or a personal garage.

In an alternative embodiment, the lateral wheels 34, 36 are interchangeable to account for different terrains. For example, larger wheels with a tire tread pattern may provide more grip for dirt, gravel, snow, or generally off-road terrain surfaces versus a smooth tire tread surface adapted for flat road surfaces, as shown. The lateral wheels 34, 36 can be changed by removing a screw 40 and a washer 42, removing the lateral wheels 34, 36 from the common axle 38, and then installing new wheels with the screw 40 and washer 42 therefrom.

The vehicle roller assembly 10 is primarily driven by a hub wheel assembly 44. The hub wheel assembly 44 is centrally positioned between the front end 18 and the rear end 20 of the frame 12 and between the right side member 14 and the left side member 16 and secured to the right side member 14 and left side member 16 with a screw 50 and washer 52. The hub wheel assembly 44 is positioned centrally within the vehicle roller assembly 10, preferably behind the lateral wheels 34, 36. In a preferred embodiment, the distance spaced apart between the right side member 14 and the left side member 16 is defined as the approximate width of the hub wheel assembly 44. In the disclosed embodiment, the approximate width of the hub wheel assembly 44 is 136 mm (˜5.35 inches). The approximate width of the hub wheel assembly 44 is not limiting.

The hub wheel assembly 44 includes a motor (not shown) positioned within a hub 46. The motor is constructed and arranged to provide rotation of a wheel 48 mounted to the hub 46 in a forward or rearward direction for propelling the frame 12. The motorized movement eliminates the need for manual pushing, providing a convenient and efficient way to relocate a vehicle. In a preferred embodiment, the hub wheel assembly 44 provides a brushless motor with a maximum voltage of 24V or 36V with 200 W of power, delivering a maximum speed of 6 km/h to 8 km/h (˜3.75 mph to ˜5 mph). In a most preferred embodiment, the hub wheel assembly includes a gear train reduction drive which multiplies the torque and reduces the rotational speed of the hub wheel.

The wheel 48 provides enough friction to be able to grip the road surface and propel the frame 12 in a forward or rearward direction. Over time, the tread of the wheel 48 will wear down. The tread of the wheel 48 is replaceable by entirely detaching the hub wheel assembly 44 from the right side member 14 and the left side member 16 by removing a screw 50 and a washer 52. Once the hub wheel assembly 44 is removed, the tread of the wheel 48 may be peeled off or pried off the hub 46 using a tool. A new tread may be fitted directly onto the wheel 48 and reinstalled onto the vehicle roller assembly 10 by securing the hub wheel assembly 44 between the right side member 14 and the left side member 16 using the screw 50 and washer 52. In a preferred embodiment, the wheel 48 is between 100 mm (˜4 inches) in diameter and 115 mm (˜4.5 inches) in diameter with new tread attached to the wheel 48. The size of the wheel is not limiting.

Electrical power is provided to the components of the vehicle roller assembly 10 by a battery 54 mounted along the rear end 20 of the frame 12 and electrically coupled to the motor via a hub motor wheel wire 56. The hub motor wheel wire 56 protrudes from the side of the hub wheel assembly 44 so as to not interfere with the wheel 48 during movement. In the disclosed embodiment, the hub motor wheel wire 56 passes through the inside of the screw 50, providing neat and organized wiring to the outer side surface 28 leading to a power terminal wire on the battery 54. The battery 54 provides the necessary power to facilitate propulsion to move the vehicle roller assembly 10 forward or rearward and ensures a reliable and consistent source of energy for the motorized operation of the device.

In a preferred embodiment, the battery 54 is replaceable and rechargeable. A new battery may be substituted directly by disconnecting the electrical connections, removing the battery 54 off the rear end 20 of the frame 12 and replacing it with the new battery, ensuring that the electrical connections are properly attached to the new battery. Alternatively, the battery 54 may be plugged in via an external charger at a charging port 58. In a preferred embodiment, the battery 54 is a 48V lithium battery providing a capacity of between 10 Ah to 20 Ah and is powered by an external 54.6V 2 A charger with a charge time of between 4 and 5 hours.

Managing and coordinating the electrical components of the vehicle roller assembly 10 are achieved via a controller 60 coupled to the battery 54 and the motor, providing directional control of the hub wheel assembly 44. The controller 60 is responsible for directing the motor within the hub wheel assembly 44 to rotate the wheel 48 in specific directions. This control mechanism allows users to dictate whether the vehicle roller assembly 10 moves forward or rearward. The directional control ensures that the device can be maneuvered with accuracy and responsiveness, enhancing its usability in various situations. The controller 60 is electronically coupled to the battery 54 by power wires 62, which include pin connectors and waterproof cables to prevent damage from the elements while ensuring a stable connection.

The controller 60 enables users to regulate the speed of the motorized movement. By adjusting the speed settings, users can control the pace at which the vehicle roller assembly 10 moves. This feature is particularly valuable in situations where precise control over speed is essential, such as when navigating through tight spaces or positioning the inoperative vehicle with care. In an alternative embodiment, the controller 60 may incorporate safety features to enhance the overall safety of the device. This could include emergency stop functionalities or safeguards to prevent sudden accelerations or decelerations. The inclusion of safety features ensures that users have the ability to quickly halt movement if necessary, mitigating potential risks during operation. In a preferred and non-limiting embodiment, the controller 60 provides a voltage of 24V, 36V, or 48V with 480 W of power.

The vehicle roller assembly 10 includes a handle 64 having a proximal end 66 secured to the rear end 20 of the frame 12 and extending outwardly therefrom to a distal end 68. The handle 64 provides users with a means to exert control over the movement of the vehicle roller assembly 10. By grasping the handle 64, users can guide the device in the desired direction. Importantly, the handle 64 provides leverage for the user to press the roller element 30 against the tire of the vehicle. This action ensures proper engagement between the roller element 30 and the tire, facilitating smooth and efficient movement. The leverage from the handle 64 makes it easier for users to apply the necessary force without excessive physical exertion.

In a preferred embodiment, the handle 64 is elongated and curved towards a user's arm-reach to provide enough leverage and ergonomic support for applying the necessary force. Necessary force is defined as the minimum amount of force the user applies downwards on the handle 64 for the roller element 30 to be able to engage with and create a rotating means between the roller element 30, the wheel of the vehicle, and the road surface. The shape, size, and material of the handle 64 is not limited. In an alternative embodiment, the design of the handle 64 may also consider compact storage, allowing it to be folded or retracted when not in use, enhancing the portability and storage convenience of the device, making it suitable for emergency situations where space may be limited or convenient to store within a mechanic's shop or personal garage.

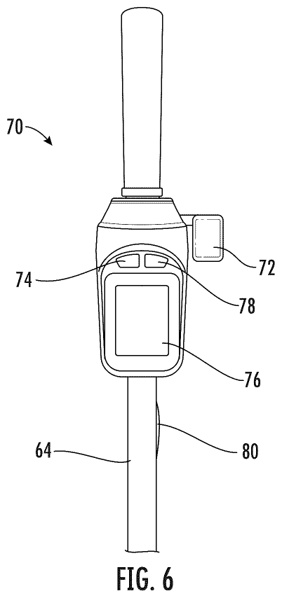

A user is able to control the direction and speed of the vehicle roller assembly 10 by using a throttle grip unit 70 culminated into the handle 64, as shown in FIG. 6. The throttle grip unit 70 fastened to the distal end 68 of the handle 64 is used to direct power from the battery 54 to the motor while a user simultaneously exerts force onto the handle 64 to initiate movement of the vehicle roller assembly 10. The throttle grip unit 70 acts as the interface through which users control the motorized movement of the vehicle roller assembly 10. By manipulating a finger operated throttle 72, users can regulate the power supplied to the motor within the hub wheel assembly 44 from the battery 54. This control allows for seamless initiation, acceleration, and deceleration of the device, offering users precise command over its speed and direction. The throttle grip unit 70 enables users to set variable speeds for the motorized movement. This feature is valuable for adapting to different scenarios, providing the flexibility to move the inoperative vehicle at a controlled pace.

The throttle grip unit 70 provides a button operated on/off switch 74 coupled to the controller 60 and an LCD display panel 76 for display of battery conditions. In an alternative embodiment, the LCD display panel 76 is able to display alternative information, such as speed and direction. Information displayed on the LCD display panel 76 may be changed to the user's desired preference via an information button 78 on the throttle grip unit 70.

In a preferred embodiment, the throttle grip unit 70 is electronically coupled to the controller 60 via an electronic throttle wire 80. The electronic throttle wire 80 may run through the handle or be discretely hidden beneath the handle, as shown. The connection between the throttle grip unit 70 and the controller 60 is not limited. In a preferred embodiment, the electronic throttle wire 80 includes pin connectors to power the LCD display panel 76 and waterproof cables to transfer electrical power while concurrently being exposed to the elements.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements, possesses those one or more steps or elements, but is not limited to possessing only those one or more elements. Likewise, a step of a method or an element of a device that “comprises,” “has,” “includes,” or “contains” one or more features, possesses those one or more features, but is not limited to possessing only those one or more features. Furthermore, a device or structure that is configured in a certain way is configured in at least that way, but may also be configured in ways that are not listed.

It is to be understood that while a certain form of the invention is illustrated it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A vehicle roller assembly for movement of a vehicle comprising:
a frame having a right side member spaced apart from a left side member, said right side member having a front end and a rear end with an upper edge and a lower edge defining an inner side surface and an outer side surface, said left side member forming a mirror image of said right side member;
a roller element rotatably positioned between said right side member and said left side member approximate said front end;
a wheel assembly positioned adjacent to said roller assembly, said wheel assembly having a first lateral wheel located along the outer side surface of said right side member and a second lateral wheel located along the outer side surface of said left side member supported by a common axle therebetween;
a hub wheel assembly centrally positioned between said front end and said rear end of said frame and said side members, said hub wheel assembly including a motor positioned within a hub, said motor constructed and arranged to provide rotation of a wheel mounted to said hub in a forward or rearward direction for propelling said frame;
a battery mounted along said rear end of said frame and electrically coupled to said motor;
a controller coupled to said battery and said motor providing directional control of said hub assembly;
a handle having a proximal end secured to the rear end of said frame and extending outwardly therefrom to a distal end; and
a throttle grip unit fastened to said distal end of said handle wherein said throttle grip is used to direct power from said battery to said motor while a user simultaneously exerts force onto said handle to initiate movement of said vehicle roller assembly.

2. The vehicle roller assembly according to claim 1, wherein said throttle grip unit includes a finger operated throttle for directing power from said battery to said motor to initiate movement of said vehicle roller assembly.

3. The vehicle roller assembly according to claim 1, wherein said controller is coupled to a button operated on/off switch and an LCD display panel for display of battery condition.

4. The vehicle roller assembly according to claim 1, wherein said roller element is a low-friction roller which greatly reduces the resistance between said roller element and the wheel of a vehicle.

5. The vehicle roller assembly according to claim 1, wherein said first lateral wheel and said second lateral wheel are interchangeable to account for different terrains.

6. The vehicle roller assembly according to claim 1, wherein the distance spaced apart between said right side member and said left side member is defined as the approximate width of said hub wheel assembly.

7. The vehicle roller assembly according to claim 6, wherein said approximate width of said hub wheel assembly is 136 mm (˜5.35 inches).

8. The vehicle roller assembly according to claim 1, wherein said motor within said hub of said hub wheel assembly is a brushless motor with a maximum voltage of 24V or 36V with 200 W of power, delivering a maximum speed of 6 km/h to 8 km/h (˜3.75 mph to ˜5 mph).

9. The vehicle roller assembly according to claim 1, wherein said wheel mounted to said hub of said hub wheel assembly includes a replaceable tread.

10. The vehicle roller assembly according to claim 9, wherein said wheel mounted to said hub of said hub wheel assembly is 100 mm (˜4 inches) in diameter and 115 mm (˜4.5 inches) in diameter with new tread attached to said wheel.

11. The vehicle roller assembly according to claim 1, wherein said battery is a 48V lithium battery providing a capacity of between 10 Ah to 20 Ah and is powered by an external 54.6V 2 A charger with a charge time of between 4 and 5 hours.

12. The vehicle roller assembly according to claim 1, wherein said controller is electronically coupled to said battery by power wires, said power wires including pin connectors and waterproof cables to prevent damage from the elements while ensuring a stable connection.

13. The vehicle roller assembly according to claim 1, wherein said controller incorporates safety features to enhance the overall safety of the device, said safety features including emergency stop functionalities or safeguards to prevent sudden accelerations or decelerations.

14. The vehicle roller assembly according to claim 1, wherein said controller provides a voltage of 24V, 36V, or 48V with 480 W of power.

15. The vehicle roller assembly according to claim 1, wherein said handle is foldable and retractable when not in use.

16. The vehicle roller assembly according to claim 3, wherein said LCD display panel displays alternative information, such as speed and direction.

17. The vehicle roller assembly according to claim 3, wherein said throttle grip unit is electronically coupled to said controller via an electronic throttle wire, said electronic throttle wire including pin connectors to provide power to said LCD display panel and waterproof cables to transfer electrical power while concurrently being exposed to the elements.
